(19) United States
(12) Patent Application Publication
(10) Pub. No.: US 2025/0034018 A1
(43) Pub. Date: Jan. 30, 2025

(54) STAGED METHODS AND SYSTEMS FOR THE VALORIZATION OF SLUDGE AND BIOSOLIDS

(71) Applicant: Texas Tech University System, Lubbock, TX (US)

(72) Inventors: Gerardine G. BOTTE, Lubbock, TX (US); Eshan ABBASI, Lubbock, TX (US); Christian E. ALVAREZ-PUGLIESE, Lubbock, TX (US)

(73) Assignee: TEXAS TECH UNIVERSITY SYSTEM, Lubbock, TX (US)

(21) Appl. No.: 18/909,776

(22) Filed: Oct. 8, 2024

Related U.S. Application Data
(63) Continuation-in-part of application No. PCT/US2024/033133, filed on Jun. 7, 2024.
(60) Provisional application No. 63/506,601, filed on Jun. 7, 2023.

(51) Int. Cl. C02F 11/00; C02F 103/20; C02F 103/32; C05F 3/00; C05F 7/00; C05F 9/00

(52) U.S. Cl. CPC C02F 11/006; C05F 3/00; C05F 7/005; C05F 9/00; C02F 2103/20; C02F 2103/32; C02F 2201/46115; C02F 2301/08; C02F 2305/023

(57) ABSTRACT

Methods and systems for pre-treatment of sludge and biosolids in preparation for electrochemical valorization is disclosed herein. Such methods can include selecting a sludge source; preparing a slurry, where the slurry comprises the sludge source and an electrolyte; adjusting a pH of the slurry, where the adjusting the pH of the slurry results in the slurry having an adjusted pH in a range between approximately 8 and 13; flowing the slurry through a first electrochemical cell, where the first electrochemical cell enables partial oxidation of the sludge via hydroxyl radicals; and flowing the partially oxidized slurry from the first electrochemical cell to a second electrochemical cell for selective conversion, where the second electrochemical cell includes an anode, a cathode, and a catalyst.

### CROSS-REFERENCE TO RELATED PATENT APPLICATIONS

This continuation-in-part application claims priority to PCT Application No. US2024/033133, filed Jun. 7, 2024, entitled “Methods And Systems For The Electrocatalysis Of Municipal Sludge And Biosolids,” which claims priority to U.S. Appl. Ser. No. 63/506,601, filed Jun. 7, 2023, entitled “Methods And Systems For The Electrocatalysis Of Municipal Sludge And Biosolids,” which patent applications are commonly owned by the owner of the present invention. These patent applications are incorporated herein in their entirety.

### STATEMENT OF FEDERALLY FUNDED RESEARCH

The present invention was funded by the National Science Foundation Center for Advancing Sustainable and Distributed Fertilizer production, CASFER, NSF 20-553 Gen-4 Engineering Research Centers award #2133576. The government has certain rights in the invention.

### TECHNICAL FIELD

The present disclosure relates to an improved method and system for the electrolysis of biosolids, sludge, food waste, manure. In particular, the present disclosure relates to the electrocatalysis of sludge on transition metal based electrodes in order to produce synthetic nitrogen based fertilizer, phosphorus based fertilizer, and an electrolyzed solid organic fertilizer from waste activated sludge, manure from concentrated animal feeding operations, and food waste.

Further, the present disclosure relates to an improved method and system for the pre-treatment and electrolysis of biosolids, sludge, food waste, and manure. In particular, the present disclosure can include the pre-treatment process using boron-doped diamond (BDD) assisted electrodes to enhance the solubility of bio-solids, improving the digestibility of the material prior to electrocatalysis. This pre-treatment step can enhance the conversion efficiency of sludge into synthetic nitrogen-based fertilizer, phosphorus-based fertilizer, and an electrolyzed solid organic fertilizer, facilitating faster and more efficient conversion to valuable products such as ammonia, with reduced energy requirements compared to traditional waste treatment processes.

### BACKGROUND

There is need to produce nitrogen based fertilizer and phosphorus based fertilizer from municipal sludge, sludge from concentrated animal feeding operations, food waste, and other like sources.

A tremendous amount of waste activated sludge ends up in landfilling even after a substantial retention time during anaerobic digestion. Waste activated sludge is the major byproduct of municipal wastewater treatment plants. Management and disposal of waste activated sludge create challenges for wastewater treatment plants such as high energy consumption and operational costs.

Waste activated sludge contains organic material like lignocellulosic waste that could be converted to produce high value chemicals such as volatile fatty acids. Accordingly, the leftover activated sludge is an organic-rich material with the high potential to produce value-added chemicals such as short chain fatty acids.

Currently, municipal sludge disposal is expensive. For example, nearly sixty percent of the operational costs in a municipal wastewater treatment plant cost between $220 and $1,000 per ton of nitrogen, and over 1.4 million tons of nitrogen from sludge are disposed in land fields each year.

Typically, sludge cannot be used as a fertilizer due to the presence of micro-organisms and other organic contaminants that can be found in municipal sludge.

Sludge in concentrated animal feeding operations, such as lagoons, also contain nitrogen varying from 5 to 10% weight. Phosphorus is also present in these streams with most of the concentration in the solids.

Currently, concentrated animal feeding operations in the United States generate nitrogen waste equivalent to 16 to 22 million tons per year. The amount of nitrogen generated is greater than that needed per year for the annual domestic consumption of nitrogen based fertilizer.

Livestock facilities in the United States produce up to 20 times more manure than people, equivalent to 1.3 billion tons of waste. Nonetheless, there are no treatment plants for those livestock facilities. Therefore, manure management technologies are also of need for concentrated animal feeding operations, as most facilities are not located at points where manure can be applied to the field.

In addition, excessive direct application of untreated manure to the field creates environmental challenges, as nutrients overwhelm the absorptive capacity of the soil, and either run off or are leached into the groundwater.

Moreover, the valorization of municipal sludge and sludge from concentrated animal feeding operations (CAFOs) into valuable products remains an unmet challenge. These waste streams not only contribute to environmental pollution but also represent an underutilized resource for the production of nitrogen-based fertilizers (NBF) and phosphorus-based fertilizers (PBF). Current disposal practices, such as landfilling, result in significant greenhouse gas emissions and contribute to soil and water contamination due to the presence of pathogens, micro-organisms, and organic contaminants.

There is also a need to decarbonize the production of fertilizers and valuable chemicals derived from biosolids and sludge. Traditional methods for synthesizing NBF and PBF are energy-intensive and rely on fossil fuel-based processes, exacerbating environmental concerns. The revalorization of biosolids into sustainable and resilient fertilizer production could help mitigate emissions, reduce reliance on nonrenewable resources, and promote a circular economy.

Furthermore, the sustainable production of fertilizers from municipal wastewater treatment plants (WWTPs) and CAFOs could significantly reduce operational costs for waste management while addressing critical food security, environmental, and public health concerns. The production of synthetic NBF and PBF from CAFO sludge offers an opportunity to integrate waste management with agricultural demands, reducing the ecological footprint of both industries.

Accordingly, there is a pressing need to develop new technologies that convert and facilitate the revalorization of biosolids and sludge into high-value products, minimize emissions, decarbonize fertilizer and valuable chemicals, and promote sustainable and resilient fertilizer production

Furthermore, and accordingly, there is a need for a production of synthetic like nitrogen based fertilizer and phosphorus based fertilizer from concentrated animal feeding operations that can lead to a holistic solution that addresses food production, environmental, economic, equity and health concerns.

It is therefore an objective of the present disclosure to determine the electrochemical conversion rate of municipal sludge to inorganic nitrogen and phosphorus on nickel-based electrodes and identify model compounds for sludge that can be implemented for electrocatalysts discovery in order to facilitate the production of synthetic nitrogen based fertilizer and phosphorus based fertilizer from waste activated sludge and concentrated animal feeding operations.

Another objective of the present disclosure is to, under certain embodiments, provide a staged electrochemical process for the valorization of municipal sludge and biosolids into valuable products, such as nitrogen-based fertilizers, phosphorus-based fertilizers, hydrogen, carboxylic acids, fatty acids, and alcohols. In such embodiments, a staged process, involving the use of sequential electrochemical cells for partial oxidation and selective conversion, can maximize the recovery of high-value chemicals while minimizing emissions and operational costs.

### SUMMARY OF THE DISCLOSURE

The present disclosure is directed to an improved method and system for the electrolysis of biosolids, sludge, food waste, manure. In some embodiments, the method and system involve the electrocatalysis of sludge on transition based electrodes (such as for example, nickel (Ni), copper (Cu), iron (Fe), cobalt (Co), chromium (Cr), manganese (Mn), Scandium (Sc), etc.). From this, certain embodiments of the present disclosure involve the production of synthetic nitrogen based fertilizer and phosphorus based fertilizer from waste activated sludge and concentrated animal feeding operations.

In general, in one embodiment, the disclosure features a method for electrocatalysis of sludge. The method can include selecting a sludge source. The method also can include preparing a slurry. The slurry can include the sludge source and an electrolyte. The method also can include adjusting a pH of the slurry. The adjusting the pH of the slurry can result in the slurry having an adjusted pH in a range between approximately 8 and 14. The method also can include flowing the slurry through an electrochemical cell. The electrochemical cell can include an anode, a cathode, and a catalyst. The method also can include applying a potential between the anode and the cathode. Applying the potential can include oscillating a cell voltage between the anode and the cathode at an oscillation frequency. The method also can include, resultant to the applying the potential, breaking down carbon bonds in the slurry with nitrogen and phosphorus. The method also can include releasing inorganic nitrogen and inorganic phosphorus. The method also can include obtaining an electrolyzed sludge. The electrolyzed sludge can include an electrolyzed solid organic fertilizer comprising nitrogen and phosphorus. The method can also include the introduction of a separator or membrane between the two electrodes.

In general, in another embodiment, the disclosure features a method for pre-treatment of sludge and biosolids in preparation for electrochemical valorization. The method can include selecting a sludge source. The method can include preparing a slurry. The slurry can include the sludge source and an electrolyte. The method can include adjusting a pH of the slurry to a range between approximately 8 and approximately 13. The method can include flowing the slurry through a first electrochemical cell. The first electrochemical cell can enable partial oxidation of the sludge via hydroxyl radicals. The first electrochemical cell can include a first-cell anode, a first-cell cathode, a membrane, and an electrolyte. The method can include flowing the partially oxidized slurry from the first electrochemical cell to a second electrochemical cell for selective conversion. The second electrochemical cell can include a second-cell anode, a second-cell cathode, and a second-cell catalyst.

### BRIEF DESCRIPTION OF THE DRAWINGS

Other advantages of the present disclosure will be apparent from the following detailed description of the disclosure in conjunction with embodiments as illustrated in the accompanying drawings, in which:

FIG. 1 depicts a process for the electrolysis of sludge for the production of nitrogen based fertilizer and phosphorus based fertilizer with an organic fertilizer/carbon sink, in accordance with certain embodiments of the present disclosure.

FIG. 2 depicts a system for the electrolysis of sludge for the production of nitrogen based fertilizer and phosphorus based fertilizer, in accordance with certain embodiments of the present disclosure.

FIG. 3 depicts a process for the partial oxidation of a slurry to be used in a process for the electrolysis of sludge for the production of nitrogen based fertilizer and phosphorus based fertilizer, in accordance with certain embodiments of the present disclosure.

### DETAILED DESCRIPTION OF THE DISCLOSURE

The present disclosure relates to an improved method and system for the electrolysis of biosolids, sludge, food waste, manure. In particular, the present disclosure relates to the electrocatalysis of sludge on transition based electrodes in order to produce synthetic nitrogen based fertilizer and phosphorus based fertilizer from waste activated sludge and concentrated animal feeding operations.

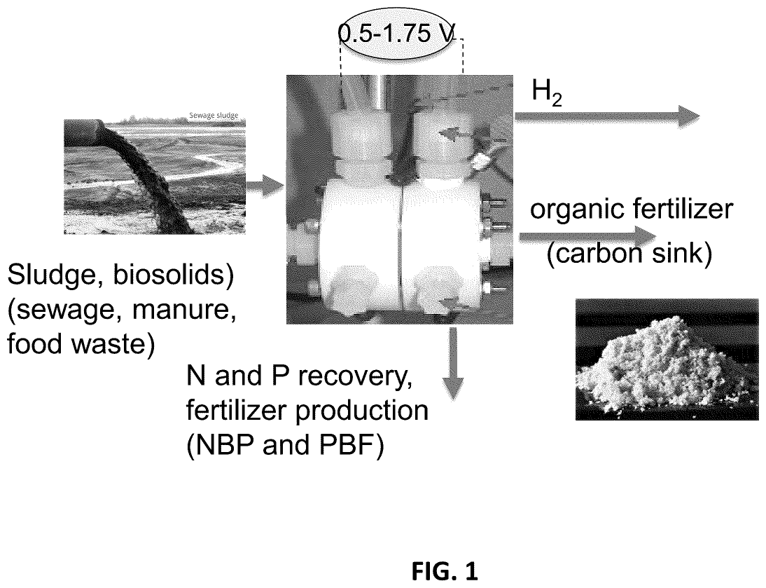

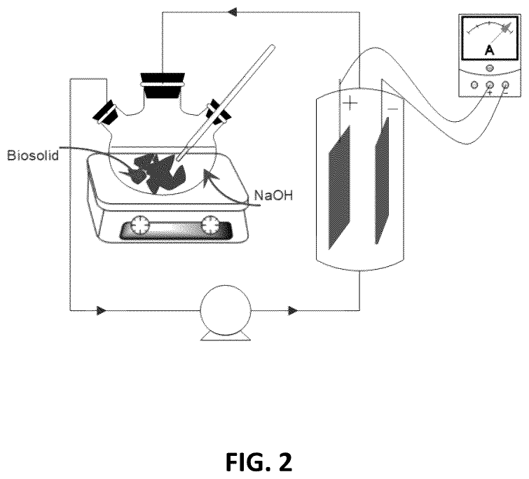

FIG. 1 depicts a process for the electrolysis of sludge for the production of nitrogen based fertilizer and phosphorus based fertilizer with an organic fertilizer/carbon sink, in accordance with certain embodiments of the present disclosure. FIG. 2 depicts a system for the electrolysis of sludge for the production of nitrogen based fertilizer and phosphorus based fertilizer, in accordance with certain embodiments of the present disclosure.

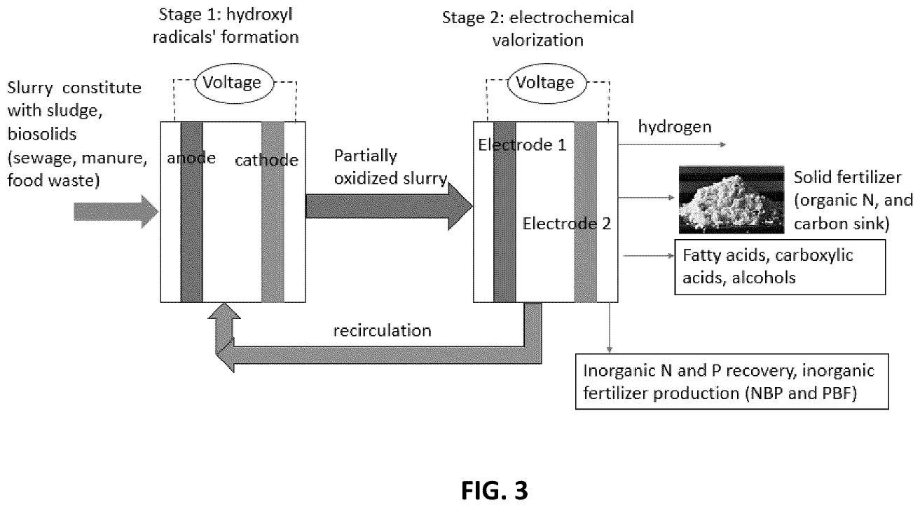

FIG. 3 depicts a process for the partial oxidation of a slurry, which is used as a pre-treatment step in the electrolysis of sludge for the production of nitrogen-based fertilizer, phosphorus-based fertilizer, according to certain embodiments of the present disclosure. The partial oxidation step facilitates the breakdown of complex organic materials in the slurry, enhancing the overall conversion efficiency of the process.

As depicted in FIG. 3, in certain embodiments, the partial oxidation process can take place in a first electrochemical cell, which includes an anode and a cathode. In some embodiments, the first electrochemical cell may also include a membrane or separator, which can be used to separate hydrogen gas generated during the process.

In some embodiments, the anode in the first electrochemical cell may be composed of a conductive material, such as Hastelloy, titanium (Ti), titanium foam, or boron-doped diamond (BDD). The anode is resistant to corrosion, which is crucial for maintaining performance over extended periods. In certain embodiments, the catalyst used at the anode can include materials such as lead dioxide (PbO₂), tin dioxide (SnO₂), antimony pentoxide (Sb₂O₅), or combinations thereof. These catalysts may have metal loadings ranging from 0.01 mg/cm² to 2 mg/cm². Additionally, boron-doped diamond (BDD) films with a thickness of 0.5-500 μm, or free-standing boron-doped diamond (BDD) electrodes, can be employed in some embodiments.

In some embodiments, the cathode in the first electrochemical cell may also be constructed from a conductive material, such as nickel gauze/mesh, stainless steel, Hastelloy, graphite, nickel foam, copper (Cu), cobalt (Co), chromium (Cr), zinc (Zn), or aluminum (Al). Other options for the cathode material include carbon fibers or graphene-based supports. The catalyst at the cathode can include transition metals such as nickel (Ni), iron (Fe), cobalt (Co), chromium (Cr), copper (Cu), zinc (Zn), ruthenium (Ru), rhodium (Rh), platinum (Pt), and iridium (Ir), or their combinations. In some embodiments, the catalysts can be used as a direct metal/support. The catalyst loadings may range from 0.1 mg/cm² to 5 mg/cm².

In some embodiments, the first electrochemical cell may include a membrane, such as nafion or fritted glass, or a separator, such as polyethylene. The membrane allows for the separation of hydrogen gas, which may evolve during the electrochemical reaction.

The electrolyte used in the first electrochemical cell can consist of a strong or weak base, such as potassium hydroxide (KOH), sodium hydroxide (NaOH), or calcium oxide (CaO). These bases are added in concentrations sufficient to maintain the pH of the slurry between 8 and 13. The electrolyte also helps facilitate the electrochemical reaction by providing the necessary ionic conductivity.

In some embodiments, as depicted in FIG. 3, during operation, the slurry flows through the electrochemical cell. The slurry may include manure, municipal sludge, food waste, and electrolyte. In such embodiments, a potential can be applied between the anode and cathode, generating hydroxyl radicals (OH) at the anode. The hydroxyl radicals are highly reactive species with a standard oxidation-reduction potential of 2.8 V, second only to fluorine. These radicals initiate the partial oxidation of organic compounds, such as proteins, per- and polyfluoroalkyl substances (PFAs), pharmaceuticals, and other contaminants.

The cell voltage applied between the anode and the cathode, in some embodiments, ranges from 2-3 V versus the standard hydrogen electrode (SHE), corresponding to a cell voltage of 3-5 V, excluding ohmic resistance. The voltage must be sufficient to drive oxygen evolution for the production of hydroxyl radicals. The duration of the partial oxidation process can vary from a few minutes to several hours, depending on the composition of the slurry and its solids content. In some embodiments, the process involves alternating between rapid stage 1 electrolysis and longer stage 2 electrolysis cycles to optimize product purity and yield. The process temperature is controlled within a range of 20-85° C.

The slurry used in the process may contain biosolids, which consist of sludge, food waste, and other organic materials. The solids content of the slurry may range from 0.5% to 40% by weight, depending on the source of the biosolids.

To scale the process for industrial applications, the electrochemical reactor may include a single cell or multiple cells arranged in a stack. The stack configuration can be set up in either a parallel or bipolar arrangement, depending on the specific design requirements and desired production capacity.

After the partial oxidation step, the process may proceed to an electrochemical valorization stage, as depicted in FIG. 1. In this stage, the partially oxidized slurry from FIG. 3 undergoes further processing to produce valuable chemicals and fertilizers. In some embodiments, the slurry may be recirculated through the system for additional oxidation or may pass through multiple processing stages.

The partial oxidation process can allow the breakdown of complex organic molecules, such as proteins, into simpler components. This pre-treatment step makes the subsequent conversion of organic nitrogen into inorganic nitrogen more efficient. Hydroxyl radicals produced at the anode attack the globular structures of proteins, PFAs, pharmaceuticals, and other contaminants. Due to the high reactivity of hydroxyl radicals, care is taken to limit the exposure time to avoid complete mineralization of the slurry into carbon dioxide (CO₂), nitrogen gas (N₂), and water (H₂O).

Accordingly, in some embodiments as shown in FIG. 3, following the partial oxidation, the pre-treated slurry can be further electrolyzed using transition metal-based electrodes, which are more selective in converting organic nitrogen into inorganic nitrogen. This additional electrolysis step enables the production of valuable chemicals, including fatty acids, carboxylic acids, and alcohols, from the biosolids.

As shown in FIG. 1, the present disclosure relates to a method and system for the electrolysis of biosolids, sludge, food waste, manure. The process, as shown in FIG. 1, the process may transform municipal sludge, manure, concentrated animal feeding operations sludge, and food waste into nitrogen based fertilizer, phosphorus based fertilizer, ammonia, slow-release organic fertilizer, and carbon sink char. The process of FIG. 1 provides the conversion and valorization of municipal and concentrated animal feeding operations sludge into value products such as ammonia, low-release organic fertilizer, phosphorus, and soil enhancement nutrient with the ability to serve as a carbon sink.

The process may result in the products of inorganic nitrogen-based fertilizer, inorganic phosphorus based fertilizer, fatty acids, hydrogen, and organic N—P fertilizer. For example, in some embodiments, the inorganic nitrogen-based fertilizer may be ammonia, ammonium salts, calcium nitrate, or combinations thereof. For example, in some embodiments, the inorganic phosphorus-based fertilizer may be one or more calcium phosphates.

In some embodiments, for example, the slow-release organic fertilizer may be or include electrolyzed biosolids. In such an embodiment, the fertilizer may contain consistent nitrogen and phosphorus content and a microstructure to enhance plant growth due to slow release of nitrogen increasing nutrient use efficiency. In some embodiments, the method and system for the electrolysis can include carbon sink material, since electrolyzed biosolids, such as those in a slow-release organic fertilizer, have the property to absorb carbon dioxide.

As shown in FIG. 1, the process may begin with the introduction of sludge. In some embodiments, the sludge may be sewage. In other embodiments, the sludge may be manure. In certain embodiments, the sludge may be a combination of one or more of municipal sludge, manure, concentrated animal feeding operations sludge, and food waste.

The process may continue with the preparation of a slurry. In such an embodiment, the slurry can include the sludge and an electrolyte. The sludge may include between approximately 0.5 percent and 40 percent solids as a mass percentage of solute in the solution.

The process may involve, in certain embodiments, the adjustment of the pH of the slurry. In some embodiments, the pH of the slurry may be adjusted between 8 and 14 using potassium hydroxide (KOH), sodium hydroxide (NaOH), calcium oxide (CaO), or other equivalent salt. These salts can also serve as electrolyte in the slurry. Operating the process at higher pH values is feasible but the range provided presents an economic advantage.

In some embodiments, the process can include partially oxidizing the slurry of biosolids.

As shown in FIG. 1, the process can include flowing the slurry through an electrochemical cell containing two electrodes, an anode and cathode. In some embodiments, the electrochemical cell can also include a membrane or separator. In such an embodiment, the addition of separator allows the separation of hydrogen gas that can evolve under certain applied voltages. In certain embodiments, the electrochemical cell can contain an anode, a cathode, a membrane or separator for collecting hydrogen, an electrolyte, and a reference electrode.

In some embodiments, the anode may include a conductive material, support, such as for example but not limited to, (Ni) gauze/mesh, stainless steel, Hastelloy, graphite, nickel (Ni), nickel (Ni) foam, copper (Cu), cobalt (Co), chromium (Cr), zinc (Zn), titanium (Ti), titanium (Ti) foam, aluminum (Al), aluminum (Al) foam, vanadium (V), manganese (Mn), Scandium (Sc), Ruthenium (Ru), Rhodium (Rh), Iron (Fe), Platinum (Pt), Silver (Ag), Gold (Au), or combinations thereof. In some embodiments, the anode may include any conductive material that is resistant to corrosion based on the electrolyte, cell voltage and temperature of the system. In some embodiments, the supports can include carbon, carbon fibers, graphene. In some embodiments, the anode may include a catalyst that includes metals such as nickel (Ni), iron (Fe), cobalt (Co), chromium (Cr), copper (Cu), zinc (Zn), ruthenium (Ru), rhodium (Rh), vanadium (V), manganese (Mn), titanium (Ti), Scandium (Sc), Platinum (Pt), Gold (Au), Silver (Ag), and combinations thereof. In some embodiments, the catalyst may include composites of graphene metal combinations. The catalyst may have loadings 0.1 mg/cm² to 2 mg/cm². The catalysts can also be used as a direct metal or support in certain embodiments.

In some embodiments, the cathode may include a conductive material, support, such as for example but not limited to, nickel (Ni) gauze/mesh, stainless steel, Hastelloy, graphite, nickel (Ni), nickel (Ni) foam, copper (Cu), cobalt (Co), chromium (Cr), zinc (Zn), titanium (Ti), titanium (Ti) foam, aluminum (Al), aluminum (Al) foam, vanadium (V), manganese (Mn), Scandium (Sc), Ruthenium (Ru), Rhodium (Rh), Iron (Fe), Silver (Ag), Gold (Au), or combinations thereof. In some embodiments, the anode may include any conductive material that is resistant to corrosion based on the electrolyte, cell voltage and temperature of the system. In some embodiments, the supports can include carbon, carbon fibers, graphene. In some embodiments, the anode may include a catalyst that includes metals such as nickel (Ni), iron (Fe), cobalt (Co), chromium (Cr), copper (Cu), zinc (Zn), ruthenium (Ru), rhodium (Rh), vanadium (V), manganese (Mn), titanium (Ti), Scandium (Sc), Silver (Ag), Gold (Au), Platinum (Pt) and combinations thereof. In some embodiments, the catalyst may include composites of graphene metal combinations. The catalyst may have loadings 0.1 mg/cm² to 2 mg/cm². The catalysts can also be used as a direct metal or support in certain embodiments.

In some embodiments, a membrane and/or a separator may be included in the electrochemical cell. Specifically, in some embodiments, the electrochemical cell may contain a membrane such as for example but not limited to nafion, fritted glass, and/or separators, such as for example but not limited to polyethylene.

In some embodiments, the electrolyte may have a strong and weak basis. For example, the electrolyte may include potassium hydroxide (KOH), sodium hydroxide (NaOH), calcium oxide (CaO), or combinations thereof. The electrolyte may be present at concentrations such that pH is maintained between approximately 8 and 14.

The process also can include applying an oscillation of potential between the two electrodes. For example, the cell voltage can be applied between the anode and the cathode of the cell. In some embodiments, a current is applied instead of a voltage. In some embodiments, the voltage can be oscillated with a frequency of 1, 10, 30, 60 seconds and 15, 30 minutes. In some embodiments, the effective cell voltage may be up to 2.5V (discounted by the ohmic resistance, counters, wires, etc.), depending on the type of electrolyte used and the temperature. The cell voltage for the electrochemical cell may vary from 0.8V to 2.5V excluding the ohmic resistance. The cell voltage applied can prevent water oxidation at the anode of the cell, and the oxidation potential is a function of the electrolyte and temperature used.

During the oscillation, in some embodiments, the temperature is controlled. For example, the temperature may be controlled between approximately 20° C. to 80° C.

By doing so, in some embodiments, the applied potential breaks down carbon bonds with nitrogen and phosphorus. As a result, in such an embodiment, the process can include releasing the nitrogen and phosphorus as inorganic phosphorus and nitrogen. For example, inorganic phosphorus may include phosphates. For example, inorganic nitrogen may be ammonia, nitrates, or combinations thereof.

The product of the process may include an electrolyzed solid containing a fraction of nitrogen and phosphorus in organic form which can be applied as an organic fertilizer. The microstructure of the electrolyzed sludge may, in some embodiments, serve as a sink for the absorption of carbon dioxide (CO₂) from the atmosphere.

Accordingly, in some embodiments, the process of FIG. 1 may reduce the time for producing organic fertilizer. In some embodiments, the fertilizer may include carbon, nitrogen, and phosphorus. For example, biological process takes 30 to 45 days to digest organic waste into fertilizer. Whereas, in the process of FIG. 1, sludge electrolysis reduces the digestion time to less than six hours. Residence time for conversion for the process of FIG. 1 may be two hours. This residence time for conversion in the process of FIG. 1 is significantly lower than processes using anaerobic digestors, which typically take approximately 10 to 20 days.

The process of FIG. 1 can result in a reduction of 24.85 percent in total solids and 46.42 percent in volatile solids, which represents approximately a 25 percent reduction in sludge disposal cost when compared to conventional treatment methods.

In some embodiments, the process can result in the conversion of 68% of the organic nitrogen into inorganic nitrogen.

### Working Example 1

A slow-release fertilizer (electrolyzed sludge) was produced using the process for the electrolysis of sludge for the production of nitrogen based fertilizer and phosphorus based fertilizer with an organic fertilizer/carbon sink. In the working example, the electrolyzed sludge (solids after electrolysis) decreased the carbon content by 20-40%, while pathogens have been destroyed. In addition, the microstructure of the material changed, creating surfaces with micro and nanoparticles. This material contained nitrogen and phosphorus in concentrations like compost. The microstructure change enabled a slow release of the fertilizer, creating an advantage in the soil. The change in the micro-structure can minimize the release of inorganic fertilizer when mixed in the soil with synthetic inorganic fertilizer.

### Working Example 2

A carbon sink material, electrolyzed sludge was produced using the process for the electrolysis of sludge for the production of nitrogen based fertilizer and phosphorus based fertilizer with an organic fertilizer/carbon sink. The electrolyzed sludge released the volatile carbon. Because of the change in the microstructure, the product behaves similar to an activated carbon, enabling the absorption of carbon dioxide (CO₂) and other contaminants. The other contaminants may include methane, benzene, toluene, or combinations thereof.

### Working Example 3

An electrolyzed sludge was produced using bovine serum albumin (BSA) as a model component for organic nitrogen. Electrolysis was carried out in a flow cell equipped with four parallel nickel electrodes (two anodes and two cathodes) with a total electrode area to volume ratio of 0.7 cm²/ml. The electrolysis was performed in the presence of 1000 ppm BSA and 1 M NaOH, with a cell voltage oscillated between +1.85V for 10 seconds and −1.85V for 1 second.

Over time, a decrease in total nitrogen was observed, indicating the production of nitrogen in gaseous form. In-line gas chromatography confirmed the production of nitrogen gas (N₂). The results demonstrate that NiOOH efficiently oxidized the protein, with the amine groups being converted to N₂ gas.

### Working Example 4

An electrolyzed sludge was produced using bovine serum albumin (BSA) as a model component for organic nitrogen in a boron-doped diamond (BDD) electrode cell. Electrolysis was conducted in an H-cell equipped with an anion exchange membrane and a stirrer, with a BDD/Hg/HgO/Pt electrode configuration. The feed solution consisted of 10,000 ppm BSA in 1 M KOH, and the electrolysis was performed for 60, 120, 180, 240, 300, and 360 minutes, with a constant current of 16.6 mA/cm².

Ammonia production increased linearly with electrolysis time, though the effectiveness of the BDD electrode was limited by competing water electrolysis reactions. The BDD electrode demonstrated utility for partial oxidation, followed by transition metal electrodes for further nitrogen conversion.

### Working Example 5

A combined electrolysis process was conducted using boron-doped diamond (BDD) electrodes for the process of oxidation, followed by electrolysis with a gold electrode. Bovine serum albumin (BSA) was used as the model compound, with 5 hours of electrolysis in the BDD electrode, followed by 1 hour of electrolysis using an electroplated gold (Au) on titanium (Ti) electrode.

The combined process resulted in approximately 15% conversion of organic nitrogen to inorganic nitrogen. The gold (Au) electrode demonstrated significantly higher activity, with a marked increase in ammonia production and a slight reduction in nitrate concentration.

Consistent with the above disclosure, the examples of systems and methods enumerated in the following clauses are specifically contemplated and are intended as a non-limiting set of examples.
Clause 1. A method for electrocatalysis of sludge including selecting a sludge source; preparing a slurry, where the slurry includes the sludge source and an electrolyte; adjusting a pH of the slurry, where the adjusting the pH of the slurry results in the slurry having an adjusted pH in a range between approximately 8 and 14; flowing the slurry through an electrochemical cell, where the electrochemical cell includes an anode, a cathode, and a catalyst; applying a potential between the anode and the cathode, where applying the potential includes oscillating a cell voltage between the anode and the cathode at an oscillation frequency; resultant to the applying the potential, breaking down carbon bonds in the slurry with nitrogen and phosphorus; releasing inorganic nitrogen and inorganic phosphorus; and obtaining an electrolyzed sludge, where the electrolyzed sludge includes an electrolyzed solid comprising nitrogen and phosphorus.
Clause 2. The method of any foregoing clause, where the sludge source includes one or more of municipal sludge, manure, concentrated animal feeding operations sludge, and food waste.
Clause 3. The method of any foregoing clause, where the sludge source includes a solid in a mass percent in a range between approximate 0.5 and 40 percent.
Clause 4. The method of any foregoing clause, where adjusting the pH of the slurry further includes adding a salt to the slurry.
Clause 5. The method of any foregoing clause, where the salt includes using potassium hydroxide (KOH), sodium hydroxide (NaOH), calcium oxide (CaO), or combinations thereof.
Clause 6. The method of any foregoing clause, where the electrochemical cell further includes a membrane.
Clause 7. The method of any foregoing clause, where the membrane includes nafion, fritted glass, or combinations thereof.
Clause 8. The method of any foregoing clause, where the electrochemical cell further includes a separator, where the separator separates hydrogen gas.
Clause 9. The method of any foregoing clause, where the separator is polyethylene.
Clause 10. The method of any foregoing clause, where the electrochemical cell further includes a reference electrode.
Clause 11. The method of any foregoing clause, where the anode includes (Ni) gauze/mesh, stainless steel, Hastelloy, graphite, nickel (Ni), nickel (Ni) foam, copper (Cu), cobalt (Co), chromium (Cr), zinc (Zn), titanium (Ti), titanium (Ti) foam, aluminum (Al), aluminum (Al) foam, vanadium (V), manganese (Mn), Scandium (Sc), Ruthenium (Ru), Rhodium (Rh), Iron (Fe), Silver (Ag), Gold (Au), or combinations thereof.
Clause 12. The method of any foregoing clause, where the cathode includes nickel (Ni) gauze/mesh, stainless steel, Hastelloy, graphite, nickel (Ni), nickel (Ni) foam, copper (Cu), cobalt (Co), chromium (Cr), zinc (Zn), titanium (Ti), titanium (Ti) foam, aluminum (Al), aluminum (Al) foam, vanadium (V), manganese (Mn), Scandium (Sc), Ruthenium (Ru), Rhodium (Rh), Iron (Fe), Silver (Ag), Gold (Au), or combinations thereof.
Clause 13. The method of any foregoing clause, where the catalyst includes composites of graphene metal combinations.
Clause 14. The method of any foregoing clause, where the oscillation frequency of 1, 10, 30, 60 seconds and 15, 30 minutes is applied.
Clause 15. The method of any foregoing clause, where the applying an oscillating cell voltage between the anode and the cathode further includes maintaining a controlled temperature, where the controlled temperature is in a range of approximately 20° C. and 80° C.
Clause 16. The method of any foregoing clause, where the inorganic nitrogen includes ammonia, nitrates, or combinations thereof.
Clause 17. The method of any foregoing clause, where the inorganic phosphorus includes phosphates.
Clause 18. The method of any foregoing clause, where the electrolyzed sludge includes an organic fertilizer.
Clause 19. The method of any foregoing clause, where the electrolyzed sludge comprises a microstructure, where the microstructure of the electrolyzed sludge serves as a sink for the absorption of carbon dioxide (CO₂).
Clause 20. The method of any foregoing clause, where the cell voltage varies from approximately 0.8V to approximately 2.0V excluding ohmic losses.
Clause 21. The method of any foregoing clause, where the applying the potential between the anode and the cathode further includes preventing water oxidation at the anode.
Clause 22. The method of any foregoing clause, where the organic fertilizer comprises carbon, nitrogen, and phosphorus.
Clause 23. A electrolyzed solid organic fertilizer including nitrogen, carbon, and phosphorus.
Clause 24. The electrolyzed solid organic fertilizer of any foregoing clause, where the electrolyzed solid organic fertilizer promotes a nitrogen circular economy.
Clause 25. The electrolyzed solid organic fertilizer of any foregoing clause, where the electrolyzed solid organic fertilizer facilitates reduced runoff.
Clause 26. A method for staged electrochemical valorization of sludge and biosolids including selecting a sludge source; preparing a slurry, where the slurry comprises the sludge source and an electrolyte; adjusting a pH of the slurry, where the adjusting the pH of the slurry results in the slurry having an adjusted pH in a range between approximately 8 and 13; flowing the slurry through a first electrochemical cell, where the first electrochemical cell enables partial oxidation of the sludge via hydroxyl radicals; and flowing the partially oxidized slurry from the first electrochemical cell to a second electrochemical cell for selective conversion, where the second electrochemical cell includes an anode, a cathode, and a catalyst.
Clause 27. The method of any foregoing clause, further including applying a potential between the anode and the cathode, where applying the potential comprises oscillating a cell voltage between the anode and the cathode at an oscillation frequency.
Clause 28. The method of any foregoing clause, further including, resultant to the applying the potential, breaking down carbon bonds in the slurry with nitrogen and phosphorus.
Clause 29. The method of any foregoing clause, further including releasing inorganic nitrogen and inorganic phosphorus.
Clause 30. The method of any foregoing clause, further including producing obtaining an electrolyzed sludge, wherein the electrolyzed sludge comprises an electrolyzed solid comprising nitrogen and phosphorus.
Clause 31. The method of any foregoing clause, where the electrolyzed sludge comprises a microstructure, where the microstructure of the electrolyzed sludge serves as a sink for the absorption of carbon dioxide (CO₂).
Clause 32. The method of any foregoing clause, where the sludge source comprises one or more of municipal sludge, manure, concentrated animal feeding operations sludge, and food waste.
Clause 33. The method of any foregoing clause, where the electrolyte comprises an alkali metal hydroxide selected from the group consisting of potassium hydroxide (KOH) or sodium hydroxide (NaOH).
Clause 34. The method of any foregoing clause, where the first electrochemical cell operates at a temperature in the range between approximately 20° C. and approximately 80° C.
Clause 35. The method of any foregoing clause, where the first electrochemical cell comprises a first anode selected from nickel, stainless steel, or graphite.
Clause 36. The method of any foregoing clause, where generation of the hydroxyl radicals facilitates the oxidation of carbon compounds present in the sludge.
Clause 37. The method of any foregoing clause, where the second electrochemical cell operates at a voltage in the range between approximately 0.8V and approximately 2.5V.
Clause 38. The method of any foregoing clause, where the second electrochemical cell further comprises a separator, wherein the separator separates hydrogen gas.
Clause 39. The method of any foregoing clause, where the separator is polyethylene.
Clause 40. The method of any foregoing clause, where the second electrochemical cell further comprises a reference electrode.
Clause 41. The method of any foregoing clause, where the electrolyzed sludge comprises an organic fertilizer.
Clause 42. The method of any foregoing clause further including producing a product comprising inorganic nitrogen and phosphorous based fertilizer, slow released organic based fertilizer, hydrogen, carboxylic acids, fatty acids, alcohols, or combinations thereof.
Clause 43. The method of any foregoing clause, where the inorganic nitrogen comprises ammonia, nitrates, or combinations thereof.
Clause 44. The method of any foregoing clause, where the inorganic phosphorus comprises phosphates.
Clause 45. The method of any foregoing clause further including recirculating the product of the second electrochemical cell back to the first electrochemical cell.
Clause 46. A method for pre-treatment of sludge and biosolids in preparation for electrochemical valorization, including selecting a sludge source, preparing a slurry where the slurry includes the sludge source and an electrolyte, adjusting a pH of the slurry to a range between approximately 8 and approximately 13, flowing the slurry through a first electrochemical cell, where the first electrochemical cell enables partial oxidation of the sludge via hydroxyl radicals, and where the first electrochemical cell includes: a first-cell anode, a first-cell cathode, a membrane, and an electrolyte; and flowing the partially oxidized slurry from the first electrochemical cell to a second electrochemical cell for selective conversion, where the second electrochemical cell includes: a second-cell anode, a second-cell cathode, and a second-cell catalyst.
Clause 47. The method of any foregoing clause, where the first-cell anode is constituted by a conductive material.
Clause 48. The method of any foregoing clause, where the conductive material includes one or more of Hastelloy, titanium (Ti), titanium foam, and boron-doped diamond (BDD).
Clause 49. The method of any foregoing clause, where the first-cell anode includes a catalyst, where the catalyst includes one or more of lead dioxide (PbO₂), tin dioxide (SnO₂), and antimony pentoxide (Sb₂Os).
Clause 50. The method of any foregoing clause, where the catalyst has metal loadings ranging from 0.01 mg/cm² to 2 mg/cm².
Clause 51. The method of any foregoing clause, where the catalyst includes boron-doped diamond (BDD).
Clause 52. The method of any foregoing clause, where the BDD is a film with a thickness of 0.5-500 μm.
Clause 53. The method of any foregoing clause, where the first-cell anode includes a free-standing BDD electrode.
Clause 54. The method of any foregoing clause, where the first-cell cathode is constituted by a conductive material.
Clause 55. The method of any foregoing clause, where the conductive material includes one or more of nickel gauze/mesh, stainless steel, Hastelloy, graphite, nickel foam, copper (Cu), cobalt (Co), chromium (Cr), zinc (Zn), titanium (Ti), titanium foam, aluminum (Al), and aluminum foam.
Clause 56. The method of any foregoing clause, where the first-cell cathode is constituted by a support selected from the group consisting of carbon, carbon fibers, and graphene.
Clause 57. The method of any foregoing clause, where the first-cell cathode includes a catalyst, where the catalyst includes one or more of nickel (Ni), iron (Fe), cobalt (Co), chromium (Cr), copper (Cu), zinc (Zn), ruthenium (Ru), rhodium (Rh), platinum (Pt), and iridium (Ir).
Clause 58. The method of any foregoing clause, where the membrane is selected from the group consisting of nafion, fritted glass, and a separator.
Clause 59. The method of any foregoing clause further including applying a potential between the first-cell anode and the first-cell cathode, where applying the potential includes oscillating a cell voltage between the first-cell anode and the first-cell cathode at an oscillation frequency.
Clause 60. The method of any foregoing clause, where the potential is applied in a range of 2 and 3 V.
Clause 61. The method of any foregoing clause further including, resultant to the applying of the potential, breaking down carbon bonds in the slurry with nitrogen and phosphorus.
Clause 62. The method of any foregoing clause further including releasing inorganic nitrogen and inorganic phosphorus.
Clause 63. The method of any foregoing clause further including producing an electrolyzed sludge, where the electrolyzed sludge includes an electrolyzed solid comprising nitrogen and phosphorus.
Clause 64. The method of any foregoing clause, where the sludge source includes one or more of municipal sludge, manure, concentrated animal feeding operations sludge, and food waste.
Clause 65. The method of any foregoing clause, where the electrolyte includes an alkali metal hydroxide selected from the group consisting of potassium hydroxide (KOH), sodium hydroxide (NaOH), lime, or calcium oxide (CaO).
Clause 66. The method of any foregoing clause, where the first electrochemical cell operates at a temperature in the range between approximately 20° C. and approximately 85° C.
Clause 67. The method of any foregoing clause, where generation of the hydroxyl radicals facilitates the oxidation of carbon compounds present in the sludge.
Clause 68. The method of any foregoing clause, where the first electrochemical cell operates at a voltage in the range between approximately 0V and approximately 5V.
Clause 69. The method of any foregoing clause, where the first electrochemical cell further includes a reference electrode.
Clause 70. The method of any foregoing clause further including recirculating the product of the second electrochemical cell back to the first electrochemical cell.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

While embodiments of the disclosure have been shown and described, modifications thereof can be made by one skilled in the art without departing from the spirit and teachings of the disclosure. The embodiments described and the examples provided herein are exemplary only, and are not intended to be limiting. Many variations and modifications of the disclosure disclosed herein are possible and are within the scope of the disclosure. The scope of protection is not limited by the description set out above, but is only limited by the claims which follow, that scope including all equivalents of the subject matter of the claims.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

### REFERENCES

Environmental Protection Agency. Detecting and mitigating the environmental impact of fecal pathogens originating from confined animal feeding operations: Review (2005). (retrieved from http://www.farmweb.org/Articles/Detecting%20and%20Mitigating%20the%20Environmental%20Impact%20of%20Fecal%20Pathogens%20Originating%20from%20Confined%20Animal%20Feeding%20Operations.pdf).
Jafari, M., Botte G. G. Electrochemical valorization of waste activated sludge for short-chain fatty acids production. Frontiers in Chemistry 10:974223 (2022).
Jafari, M., Botte, G. G. Electrochemical treatment of sewage sludge and pathogen inactivation. J Appl Electrochem 51, 119-130 (2021).
Liu, H. et al. Phosphorus recovery from municipal sludge-derived ash and hydrochar through wet-chemical technology: A review towards sustainable waste management, Chemical Engineering Journal 417, 129300 (2021).
Lu, F., Botte G. G. Understanding the electrochemically induces conversion of urea to ammonia using nickel-based catalysts, Electrochimica Acta, 246, 564-571 (2017).
Schmalzried, H. D. & Fallon, L. F., Jr. Large-scale dairy operations: Assessing concerns of neighbors about quality-of-life issues. J. of Dairy Science, 90 (4), 2047-2051 (2007) (retrieved from http://jds.fass.org/cgi/reprint/90/4/2047?maxtoshow=&hits=10&RESULTFORMAT=&fulltext=large-scale&searchid=1&FIRSTINDEX=0&volume=90&issue=4&resource type=HWC).
Zhuang, X. et al. The transformation pathways of nitrogen in sewage sludge during hydrothermal treatment, Bioresource Technology 245, 463-470 (2017).

What is claimed is:

1. A method for pre-treatment of sludge and biosolids in preparation for electrochemical valorization, comprising:
(a) selecting a sludge source;
(b) preparing a slurry, wherein the slurry comprises the sludge source and an electrolyte;
(c) adjusting a pH of the slurry to a range between approximately 8 and approximately 13;
(d) flowing the slurry through a first electrochemical cell, wherein the first electrochemical cell enables partial oxidation of the sludge via hydroxyl radicals, wherein the first electrochemical cell comprises:
(i) a first-cell anode,
(ii) a first-cell cathode,
(iii) a membrane, and
(iv) an electrolyte; and
(e) flowing the partially oxidized slurry from the first electrochemical cell to a second electrochemical cell for selective conversion, wherein the second electrochemical cell comprises:
(i) a second-cell anode,
(ii) a second-cell cathode, and
(iii) a second-cell catalyst.

2. The method of claim 1, wherein the first-cell anode is constituted by a conductive material.

3. The method of claim 2, wherein the conductive material comprises one or more of Hastelloy, titanium (Ti), titanium foam, and boron-doped diamond (BDD).

4. The method of claim 1, wherein the first-cell anode comprises a catalyst, wherein the catalyst comprises one or more of lead dioxide (PbO₂), tin dioxide (SnO₂), and antimony pentoxide (Sb₂Os).

5. The method of claim 4, wherein the catalyst has metal loadings ranging from 0.01 mg/cm² to 2 mg/cm².

6. The method of claim 4, wherein the catalyst comprises boron-doped diamond (BDD).

7. The method of claim 6, wherein the BDD is a film with a thickness of 0.5-500 μm.

8. The method of claim 1, wherein the first-cell anode comprises a free-standing BDD electrode.

9. The method of claim 1, wherein the first-cell cathode is constituted by a conductive material.

10. The method of claim 9, wherein the conductive material comprises one or more of nickel gauze/mesh, stainless steel, Hastelloy, graphite, nickel foam, copper (Cu), cobalt (Co), chromium (Cr), zinc (Zn), titanium (Ti), titanium foam, aluminum (Al), and aluminum foam.

11. The method of claim 9, wherein the first-cell cathode is constituted by a support selected from the group consisting of carbon, carbon fibers, and graphene.

12. The method of claim 1, wherein the first-cell cathode comprises a catalyst, wherein the catalyst comprises one or more of nickel (Ni), iron (Fe), cobalt (Co), chromium (Cr), copper (Cu), zinc (Zn), ruthenium (Ru), rhodium (Rh), platinum (Pt), and iridium (Ir).

13. The method of claim 1, wherein the membrane is selected from the group consisting of nafion, fritted glass, and a separator.

14. The method of claim 1 further comprising applying a potential between the first-cell anode and the first-cell cathode, wherein applying the potential comprises oscillating a cell voltage between the first-cell anode and the first-cell cathode at an oscillation frequency.

15. The method of claim 14, wherein the potential is applied in a range of 2 and 3 V.

16. The method of claim 14 further comprising, resultant to the applying the potential, breaking down carbon bonds in the slurry with nitrogen and phosphorus.

17. The method of claim 16 further comprising releasing inorganic nitrogen and inorganic phosphorus.

18. The method of claim 1 further comprising producing an electrolyzed sludge, wherein the electrolyzed sludge comprises an electrolyzed solid comprising nitrogen and phosphorus.

19. The method of claim 1, wherein the sludge source comprises one or more of municipal sludge, manure, concentrated animal feeding operations sludge, and food waste.

20. The method of claim 1, wherein the electrolyte comprises an alkali metal hydroxide selected from the group consisting of potassium hydroxide (KOH), sodium hydroxide (NaOH), lime, or calcium oxide (CaO).

21. The method of claim 1, wherein the first electrochemical cell operates at a temperature in the range between approximately 20° C. and approximately 85° C.

22. The method of claim 1, wherein generation of the hydroxyl radicals facilitates the oxidation of carbon compounds present in the sludge.

23. The method of claim 1, wherein the first electrochemical cell operates at a voltage in the range between approximately 0V and approximately 5V.

24. The method of claim 1, wherein the first electrochemical cell further comprises a reference electrode.

25. The method of claim 1 further comprising recirculating the product of the second electrochemical cell back to the first electrochemical cell.
